(19) United States
(12) Patent Application Publication
(10) Pub. No.: US 2015/0086869 A1
(43) Pub. Date: Mar. 26, 2015

(54) LITHIUM-ION BATTERY

(71) Applicant: Ningde Amperex Technology Limited, Ningde City (CN)

(72) Inventors: Xiaomei WANG, Ningde City (CN); Chenghua FU, Ningde City (CN); Changlong HAN, Ningde City (CN); Chunbo CHU, Ningde City (CN)

(73) Assignee: Ningde Amperex Technology Limited, Ningde City (CN)

(21) Appl. No.: 14/088,617

(22) Filed: Nov. 25, 2013

(30) Foreign Application Priority Data
Sep. 23, 2013 (CN) 201320587900.1

(51) Int. Cl. H01M 4/62; H01M 10/42; H01M 10/0525

(52) U.S. Cl. CPC H01M 4/628; H01M 10/0525; H01M 10/4235
USPC 429/215

(57) ABSTRACT

A lithium-ion battery, comprises an anode plate, a cathode plate, a separator and electrolyte, wherein the separator is arranged between the anode plate and the cathode plate. The anode plate comprises an anode current collector and an anode active material layer. The anode current collector is provided with an anode coating area and an anode blank area, and the anode active material layer is coated on the anode coating area. The cathode plate comprises a cathode current collector and a cathode active material layer. The cathode current collector is provided with a cathode coating area and a cathode blank area, and the cathode active material layer is coated on the cathode coating area. When both the anode blank area and the cathode blank area are coated with a polymer layer, the two polymer layers are mutually contacted.

### FIELD OF THE INVENTION

The invention belongs to the field of battery technologies, and relates to a lithium-ion battery particularly.

### BACKGROUND OF THE INVENTION

Lithium-ion batteries have the advantages of higher energy density and long cycle life when in comparison with lead-acid batteries, nickel-metal hydride batteries and nickel-cadmium batteries, and have been broadly applied to the field of consumer electronics at present.

Side reactions inside lithium ions and the safety performance of the batteries while overcharging are related to voltages of the batteries usually. On one hand, when voltages of the batteries are higher, the side reactions inside the batteries are more and performance attenuation of the batteries is more obvious. On the other hand, the safety performance of the batteries while overcharging is also related to the voltages of the batteries. The voltages are raised faster during overcharging, which will easily cause a safety problem to the batteries. Therefore, none of the lithium-ion batteries of the prior art are able to control the voltages of the batteries effectively, such that the batteries have a short service life.

### SUMMARY OF THE INVENTION

The invention aims at: providing a lithium-ion battery for solving the safety problem of lithium-ion batteries, through which voltage of the battery can be effectively controlled so as to prevent the voltage of the battery from changing abnormally, such that the lithium-ion battery can be used normally for a long period of time.

To implement the above objectives: the invention employs the following technical solution: a lithium-ion battery comprises an anode plate, a cathode plate, a separator and electrolyte, wherein the separator is arranged between the anode plate and the cathode plate. The anode plate comprises an anode current collector and an anode active material layer. The anode current collector is provided with an anode coating area and an anode blank area, and the anode active material layer is coated on the anode coating area. The cathode plate comprises a cathode current collector and a cathode active material layer. The cathode current collector is provided with a cathode coating area and a cathode blank area, and the cathode active material layer is coated on the cathode coating area. When both the anode blank area and the cathode blank area are coated with a polymer layer, the two polymer layers are mutually contacted; when one of the anode blank area and the cathode blank area is coated with a polymer layer, the polymer layer is contacted with the other blank area.

A polyaniline layer or a polyphenyl layer is configured as the polymer layer, wherein a material of the polymer layer is a material with a conductivity affected by the potential of an active material. Moreover, the anode blank area and the cathode blank area are respectively arranged at the end parts or middle parts of the anode plate and the cathode plate.

The polyaniline layer comprises polyaniline and binder. A mass ratio of the polyaniline to the binder is 1:9-9:1. Generally, the oxidation potential of the polyaniline layer is about 3.3V. The polyaniline layer cannot be directly contacted with a cathode material since the oxidation potential thereof is lower which may affect normal charging performance of the battery. The polyaniline is directly contacted with an anode. Compared with the polyphenyl layer, the polyaniline layer has better compatibility with the anode. The polyphenyl layer comprises polyphenyl and binder. A mass ratio of the polyphenyl to the binder is 1:9-9:1. Generally, an oxidation reaction may occur to the polyphenyl layer under a voltage between 4V and 4.3V, such that an electronic conductivity of the polyphenyl layer is enhanced to play a role of controlling the voltage of the battery.

The polyaniline and the polyphenyl are potential sensitive materials. The electrode potential exceeds the oxidation potential of the material while overcharging, and p-doping occurs in the polymer, an electronic conductivity feature is displayed by the polymer due to doping, and the polymer layer is switched from an insulated state into a conducting state, thus causing internal short circuit of the battery; moreover, a short circuit current causes voltage drop of the battery.

The polyaniline layer is coated on the anode blank area, and the polyphenyl layer is coated on the cathode blank area; and the polyaniline layer is contacted with the polyphenyl layer.

The polyphenyl layer is coated on the anode blank area, and the polyaniline layer is coated on the cathode blank area; and the polyaniline layer is contacted with the polyphenyl layer.

A first intermediate layer is arranged between the polymer layer and the anode blank area.

A second intermediate layer is arranged between the polymer layer and the cathode blank area.

Area of the first intermediate layer is ⅕-½ of that of the anode blank area.

Area of the second intermediate layer is ⅕-½ of that of the cathode blank area.

Intensity of a discharge current inside the battery may be controlled via a ratio of the polyaniline layer to the binder as well as a ratio of the polyphenyl layer to the binder. When mass ratios of the polyaniline layer and the polyphenyl layer are enlarged, the discharge current will be enlarged proportionally. When coating area ratios of the polyaniline layer and the polyphenyl layer are enlarged, the discharge current will also be enlarged proportionally.

The invention has the beneficial effects that: when the battery is charged to the oxidation potentials of the polyaniline layer and the polyphenyl layer, the electronic conductivities of the polyaniline layer and the polyphenyl layer are enhanced, and a controllable internal short circuit occurs via contact between the polyaniline layer and the polyphenyl layer, thus discharging excess electricity, such that the battery is under a safe state. After the excess electricity is discharged, the voltage of the battery will be slightly decreased. At this moment, the conductivities of the polyaniline layer and the polyphenyl layer will be weakened until no electron conducts electricity. Therefore, an electronic access inside the battery is cut off, and the battery is under a stable state, thus effectively controlling the voltage of the battery, such that the battery can be normally used for a long period of time.

### BRIEF DESCRIPTION OF THE DRAWINGS

FIG. 1 is a schematic structural view of embodiment 1 of the invention;

FIG. 2 is an A part enlarged view of FIG. 1;

FIG. 3 is an end part enlarged view of embodiment 2 of the invention;

FIG. 4 is an end part enlarged view of embodiment 3 of the invention;

FIG. 5 is an end part enlarged view of embodiment 4 of the invention;

FIG. 6 is an end part enlarged view of embodiment 5 of the invention;

FIG. 7 is an end part enlarged view of embodiment 6 of the invention; and

FIG. 8 is an end part enlarged view of embodiment 7 of the invention.

### DETAILED DESCRIPTION OF THE INVENTION

The following further describes the invention with reference to the embodiments and the attached drawings. However, the embodiments of the invention are not limited to this.

### Embodiment 1

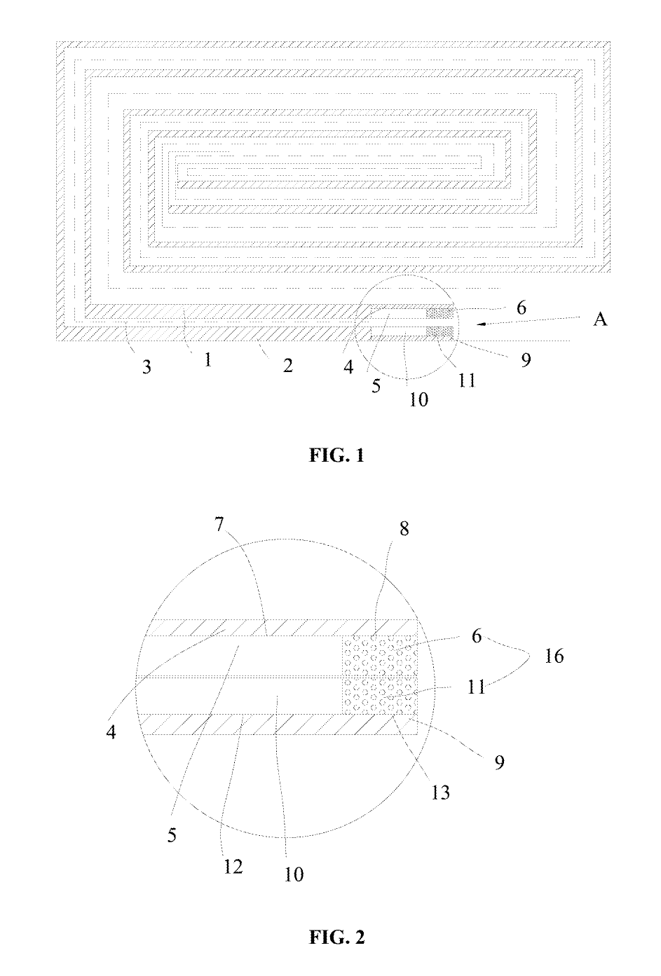

As illustrated in FIG. 1 and FIG. 2, a lithium-ion battery comprises an anode plate 1, a cathode plate 2, a separator 3 and electrolyte, wherein the separator 3 is arranged between the anode plate 1 and the cathode plate 2. The anode plate 1 comprises an anode current collector 4 and an anode active material layer 5. The anode current collector 4 is provided with an anode coating area 7 and an anode blank area 8, and the anode active material layer 5 is coated in the anode coating area 7. The cathode plate 2 comprises a cathode current collector 9 and a cathode active material layer 10. The cathode current collector 9 is provided with a cathode coating area 12 and a cathode blank area 13, and the cathode active material layer 10 is coated in the cathode coating area 12. When both the anode blank area 8 and the cathode blank area 13 are coated with a polymer layer 16, the two polymer layers 16 are mutually contacted.

A polyaniline layer 6 or a polyphenyl layer 11 is configured as the polymer layer 16. When the two polymer layers 16 are contacted, a controllable internal short circuit occurs, thus discharging excess electricity, such that the battery is under a safe state. The polyaniline layer 6 is coated on the anode blank area 8, and the polyphenyl layer 11 is coated on the cathode blank area 13; and the polyaniline layer 6 is contacted with the polyphenyl layer 11. The anode blank area 8 and the cathode blank area 13 are respectively arranged at the end parts or middle parts of the anode plate 1 and the cathode plate 2. Preferably, the anode blank area 8 and the cathode blank area 13 are arranged at the end parts.

### Embodiment 2

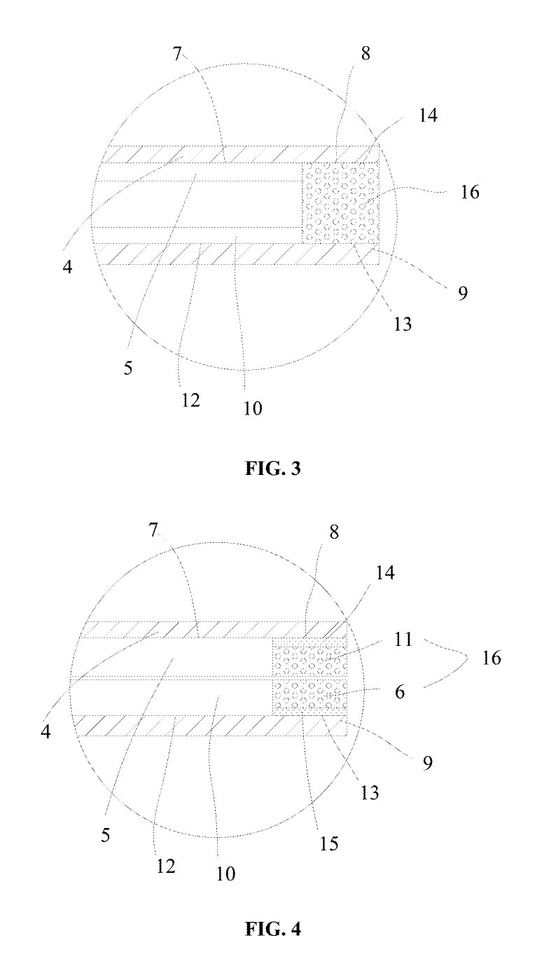

As illustrated in FIG. 3, embodiment 2 differs from embodiment 1 in that: a polyphenyl layer 11 of this embodiment is coated on an anode blank area 8; moreover, a first intermediate layer 14 is arranged between the polyphenyl layer 11 and the anode blank area 8 of the embodiment. A polyaniline layer 6 is coated on a cathode blank area 13. The polyaniline layer 6 is contacted with the polyphenyl layer 11. A potential when arranging the first intermediate layer 14 is more stable than a potential when being directly coated on an anode current collector 4. Therefore, excess electricity can be discharged quickly, such that safety of overcharging is improved. Generally, a material of the first intermediate layer 14 is the same as a material of an anode active material layer 5.

Other structures are the same as the structures of embodiment 1, which are thus not described herein any further.

### Embodiment 3

As illustrated in FIG. 4, embodiment 3 differs from embodiment 2 in that: a second intermediate layer 15 is arranged between a polyaniline layer 6 and a cathode blank area 13 of the embodiment. Thickness sum of a polyphenyl layer 11 and a first intermediate layer 14 is no more than thickness of an anode active material layer 5, and thickness sum of the polyaniline layer 6 and the second intermediate layer 15 is no more than thickness of a cathode active material layer 10, thus being beneficial for improving energy density of the battery. Moreover, an effect of discharge is better than that of embodiment 2.

Other structures are the same as the structures of embodiment 2, which are thus not described herein any further.

### Embodiment 4

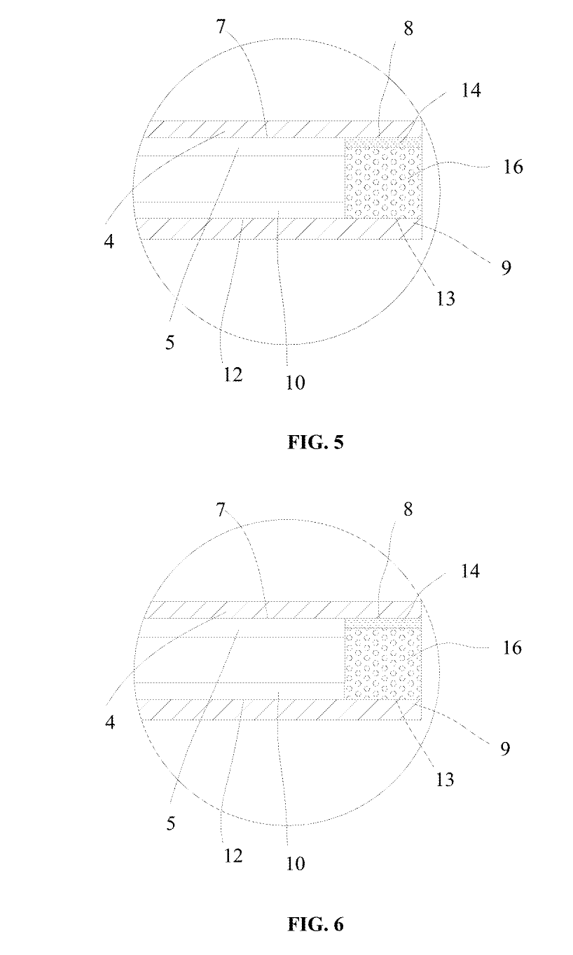

As illustrated in FIG. 5, embodiment 4 differs from embodiment 1 in that: when one of an anode blank area 8 and a cathode blank area 13 of the embodiment is coated with a polymer layer 16, the polymer layer 16 is contacted with the other blank area. There are two situations for implementing such a structure. One situation is that: the polymer layer 16 is coated on the anode blank area 8, and the polymer layer 16 is contacted with the cathode blank area 13. The other situation is that: the polymer layer 16 is coated on the cathode blank area 13, and the polymer layer 16 is contacted with the anode blank area 8.

Other structures are the same as the structures of embodiment 1, which are thus not described herein any further.

### Embodiment 5

As illustrated in FIG. 6, embodiment 5 differs from embodiment 4 in that: a first intermediate layer 14 is arranged between a polymer layer 16 and an anode blank area 8 of the embodiment.

Other structures are the same as the structures of embodiment 4, which are thus not described herein any further.

### Embodiment 6

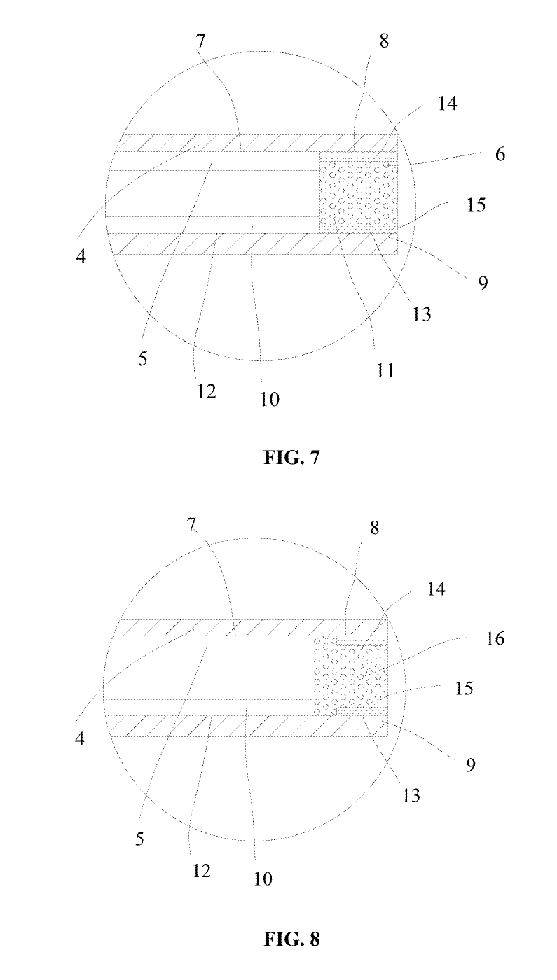

As illustrated in FIG. 7, embodiment 6 differs from embodiment 5 in that: a second intermediate layer 15 is arranged between a polymer layer 16 and a cathode blank area 13 of the embodiment.

Other structures are the same as the structures of embodiment 5, which are thus not described herein any further.

### Embodiment 7

As illustrated in FIG. 8, embodiment 7 differs from embodiment 3 in that: area of a first intermediate layer 14 of the embodiment is ⅕-½ of that of an anode blank area 8, and area of a second intermediate layer 15 is ⅕-½ of that of a cathode blank area 13. In this case, a polymer layer 16 is coated on both an anode current collector 4 and the first intermediate layer 14, and also is coated on both a cathode current collector 9 and the second intermediate layer 15. An effect of discharge of the embodiment is better than that of embodiment 4, but poorer than that of embodiment 6.

Following performance tests are implemented on the lithium-ion batteries of the invention and the lithium-ion batteries of the prior art: a plurality of cells of the lithium-ion batteries of the invention and the lithium-ion batteries of the prior art are charged to 4.3V via 1C, and the voltage is kept constant via 0.05C. The cells are arranged in a 60° C. oven for high temperature storage. After high temperature storage for three days, the voltages of the lithium-ion batteries of the prior art are all measured to be higher than that of the lithium-ion batteries of the invention. Since a controllable internal short circuit occurs to the lithium-ion battery of the invention via contact between the polyaniline layer 6 and the polyphenyl layer 11, excess electricity is discharged, such that the battery is under a safe voltage state all the time. For example, one lithium-ion battery of the invention stored under a high temperature and one lithium-ion battery of the prior art stored under a high temperature are charged via a 0.5C current. When the batteries are charged to 200% SOC (State of Charge) of the electric quantities of the batteries, the lithium-ion battery of the invention is not fired or exploded, and the voltage of the battery is 4.4-4.5 V. However, the lithium-ion battery of the prior art is fired.

The above test indicates that: when the battery of the invention is being charged, the electricity charged can be discharged and will not be accumulated to a state of causing the battery uncontrolled, such that effective control of the charging voltage of the invention is implemented, the safety performance of the lithium-ion battery is improved, and the high temperature storage performance of the battery is improved.

According to the disclosure and teaching of this Description, those skilled in the art may further alter and amend the embodiments above. Therefore, the invention is not limited to the embodiments above. Any apparent improvement, replacement or variation implemented based on the invention shall fall within the protection scope of the invention. In addition, although some specific terms are used in the Description, the terms are merely for convenience of illustration, but not intended to limit the invention.

What is claimed is:

1. A lithium-ion battery, comprising an anode plate, a cathode plate, a separator and electrolyte, wherein the separator is arranged between the anode plate and the cathode plate, the anode plate comprises an anode current collector and an anode active material layer, the anode current collector is provided with an anode coating area and an anode blank area, and the anode active material layer is coated on the anode coating area; the cathode plate comprises a cathode current collector and a cathode active material layer, the cathode current collector is provided with a cathode coating area and a cathode blank area, and the cathode active material layer is coated on the cathode coating area, wherein when both the anode blank area and the cathode blank area are coated with a polymer layer, the two polymer layers are mutually contacted; when one of the anode blank area and the cathode blank area is coated with a polymer layer, the polymer layer is contacted with the other blank area.

2. The lithium-ion battery according to claim 1, wherein a polyaniline layer or a polyphenyl layer is configured as the polymer layer; and the anode blank area and the cathode blank area are respectively arranged at the end parts or middle parts of the anode plate and the cathode plate.

3. The lithium-ion battery according to claim 2, wherein the polyaniline layer is coated on the anode blank area, and the polyphenyl layer is coated on the cathode blank area; and the polyaniline layer is contacted with the polyphenyl layer.

4. The lithium-ion battery according to claim 2, wherein the polyphenyl layer is coated on the anode blank area and the polyaniline layer is coated on the cathode blank area; and the polyaniline layer is contacted with the polyphenyl layer.

5. The lithium-ion battery according to claim 1, wherein a first intermediate layer is arranged between the polymer layer and the anode blank area.

6. The lithium-ion battery according to claim 1, wherein a second intermediate layer is arranged between the polymer layer and the cathode blank area.

7. The lithium-ion battery according to claim 5, wherein area of the first intermediate layer is ⅕-½ of that of the anode blank area.

8. The lithium-ion battery according to claim 6, wherein area of the second intermediate layer is ⅕-½ of that of the cathode blank area.
